(19) United States
(12) Patent Application Publication
(10) Pub. No.: US 2026/0278751 A1
(43) Pub. Date: Sep. 17, 2026

(54) Multi-Depth Deblur

(71) Applicant: Google LLC, Mountain View, CA (US)

(72) Inventors: Leung Chun Chan, Sunnyvale, CA (US); Tongyang Liu, Sunnyvale, CA (US); Li Wei, Mountain View, CA (US); Wei-Sheng Lai, San Mateo, CA (US); Wei Hong, Sunnyvale, CA (US); Yichang Shih, Cupertino, CA (US); Ying Chen Lou, Santa Clara, CA (US)

(21) Appl. No.: 19/472,843

(22) PCT Filed: Apr. 6, 2023
(86) PCT No.: PCT/US2023/017745

§ 371 Date: Oct. 6, 2025

(51) Int. Cl. G06T 5/73; G06T 5/60; G06T 7/50

(52) U.S. Cl. CPC G06T 5/73; G06T 5/60; G06T 7/50; G06T 2207/20012; G06T 2207/20081; G06T 2207/30201

(57) ABSTRACT

A method includes receiving, from a sensor, an image. The method also includes determining, based on the image, at least one pixel area identified to contain a region of interest within the image. The method additionally includes determining depth information for the at least one pixel area. The method further includes based on the depth information for the at least one pixel area, selecting at least one deblur model from a plurality of deblur models to apply to the at least one pixel area. The method also includes applying the selected at least one deblur model to determine a deblurred image comprising the at least one pixel area, where the at least one pixel area is deblurred based on the depth information.

### BACKGROUND

Many modern computing devices, including mobile phones, personal computers, and tablets, include image capturing devices. Some image capturing devices are configured with telephoto capabilities.

### SUMMARY

In an embodiment, a method includes receiving, from a sensor, an image. The method also includes determining, based on the image, at least one pixel area identified to contain a region of interest within the image. The method additionally includes determining depth information for the at least one pixel area. The method further includes based on the depth information for the at least one pixel area, selecting at least one deblur model from a plurality of deblur models to apply to the at least one pixel area. The method also includes applying the selected at least one deblur model to determine a deblurred image comprising the at least one pixel area, where the at least one pixel area is deblurred based on the depth information.

In another embodiment, a system includes a processor and a non-transitory computer-readable medium having stored thereon instructions that, when executed by the processor, cause the processor to perform operations. The operations include receiving, from a sensor, an image. The operations also include determining, based on the image, at least one pixel area identified to contain a region of interest within the image. The operations additionally include determining depth information for the at least one pixel area. The operations further include based on the depth information for the at least one pixel area, selecting at least one deblur model from a plurality of deblur models to apply to the at least one pixel area. The operations further include applying the selected at least one deblur model to determine a deblurred image comprising the at least one pixel area, where the at least one pixel area is deblurred based on the depth information.

In another embodiment, a computing device comprises a control system. The control system is configured to receive, from a sensor, an image. The control system is further configured to determine, based on the image, at least one pixel area identified to contain a region of interest within the image. The control system is also configured to determine depth information for the at least one pixel area. The control system is additionally configured to, based on the depth information for the at least one pixel area, select at least one deblur model from a plurality of deblur models to apply to the at least one pixel area. The control system is further configured to apply the selected at least one deblur model to determine a deblurred image comprising the at least one pixel area, where the at least one pixel area is deblurred based on the depth information.

In a further embodiment, a system is provided that includes means for receiving, from a sensor, an image. The system also includes means for determining, based on the image, at least one pixel area identified to contain a region of interest within the image. The system additionally includes means for determining depth information for the at least one pixel area. The system further includes means for, based on the depth information for the at least one pixel area, selecting at least one deblur model from a plurality of deblur models to apply to the at least one pixel area. The system also includes means for applying the selected at least one deblur model to determine a deblurred image comprising the at least one pixel area, where the at least one pixel area is deblurred based on the depth information.

The foregoing summary is illustrative only and is not intended to be in any way limiting. In addition to the illustrative aspects, embodiments, and features described above, further aspects, embodiments, and features will become apparent by reference to the figures and the following detailed description and the accompanying drawings.

### BRIEF DESCRIPTION OF THE DRAWINGS

FIG. 1 illustrates an example computing device, in accordance with example embodiments.

FIG. 2 is a simplified block diagram showing some of the components of an example computing system.

FIG. 3 is a diagram illustrating a training phase and an inference phase of one or more trained machine learning models in accordance with example embodiments.

FIG. 4 is a block diagram, in accordance with example embodiments.

FIG. 5 is an image, in accordance with example embodiments.

FIG. 6 is an image with indicated regions of interest, in accordance with example embodiments.

FIG. 7 are regions of interest, in accordance with example embodiments.

FIG. 8 illustrates images before and after processing, in accordance with example embodiments.

FIG. 9 illustrates a deblurred image with indicated regions of interests, in accordance with example embodiments.

FIG. 10 is a block diagram of a method, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless indicated as such. Other embodiments can be utilized, and other changes can be made, without departing from the scope of the subject matter presented herein.

Thus, the example embodiments described herein are not meant to be limiting. It will be readily understood that the aspects of the present disclosure, as generally described herein, and illustrated in the figures, can be arranged, substituted, combined, separated, and designed in a wide variety of different configurations.

Throughout this description, the articles “a” or “an” are used to introduce elements of the example embodiments. Any reference to “a” or “an” refers to “at least one,” and any reference to “the” refers to “the at least one,” unless otherwise specified, or unless the context clearly dictates otherwise. The intent of using the conjunction “or” within a described list of at least two terms is to indicate any of the listed terms or any combination of the listed terms The use of ordinal numbers such as “first,” “second,” “third” and so on is to distinguish respective elements rather than to denote a particular order of those elements. For the purpose of this description, the terms “multiple” and “a plurality of” refer to “two or more” or “more than one.”

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment. In the figures, similar symbols typically identify similar components, unless context dictates otherwise. Further, unless otherwise noted, figures are not drawn to scale and are used for illustrative purposes only. Moreover, the figures are representational only and not all components are shown. For example, additional structural or restraining components might not be shown.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

### I. Overview

A computing system may have and/or communicate with one or more sensors, such as cameras. These sensors may be able to capture images, which may be of various subjects, including people, the environment, scenery, among other examples. The sensors may focus on a particular object or person in the image. For example, if the image is of a person in front of another person, the person in the front may be in focus. As another example, if the image is of a person standing in front of a store, the person may be in focus. As a yet further example, if the image is of a sign in front of a store, the sign in front of the store may be in focus.

An issue may arise where one or more subjects in the image are not in focus and/or where various post processing algorithms overcompensate to fix the out of focus subject(s). For example, for an image with two people, only one person may be in focus or neither person may be in focus. A post processing algorithm may be applied in an attempt to fix this issue, but the resulting image may appear unnatural, perhaps due to the post processing methodology attempting to apply deblurring algorithms uniformly across all out of focus regions.

Provided herein are methods for a multi-depth deblur system that may allow for various degrees of deblurring to be applied across one or more regions of interest in an image, which may result in the deblurred image appearing more realistic and less processed. In particular, a computing system may determine depth measurements for various regions of interest in an image, and the computing system may apply an amount of deblurring to a region of interest in the image based on the region of interest's associated depth measurement. In some examples, the computing system may select a deblurring model to apply from a plurality of deblurring models based on the depth measurement.

The computing system may include or may communicate with a sensor, which may capture an image. In some examples, the sensor may be part of a camera and the computing system may be a phone. Additionally and/or alternatively, a remotely operated camera may periodically capture images and send images to a server device, which may then process the images. Other examples of sensors and computing systems are also possible.

After receiving an image from a sensor, the computing system may then determine that at least one pixel area contains a region of interest in the image. For example, in an image with one person in front of another person, the pixel areas containing either person and/or either person's face may each be identified as a region of interest. In an image with a person standing in front of a store, the pixel area containing the person may be a region of interest. And in an image of a sign in front of a store, the pixel area containing the sign in front of the store may be a region of interest. The computing system may determine one or more pixel areas that each contain a region of interest, and each pixel area may include a different region of interest.

Based on the identified pixel area(s), the computing system may then determine depth information for the pixel areas. The depth information may include depth values, perhaps mapped to an identifier for each pixel area. The depth values may represent a distance from the sensor to the subject portrayed in the region of interest in the image. For example, if the region of interest includes a person, the depth value may represent a distance from the sensor to the person. The computing system may determine the depth information based on the image and/or identified pixel area(s). In some examples, the depth information may be further based on data from one or more additional sensors (e.g., light detection and ranging (LIDAR) sensors). Additionally and/or alternatively, the computing system may calculate the depth information from the received image and an additional image, where the received image and the additional image may have different fields of view. In some examples, the process of determining depth information for the identified pixel areas may involve a region of interest processing module, which may take an indication of the at least one pixel area as an input and output depth information for each pixel area.

After having determined the depth information, the computing system may then select a deblur model from a plurality of deblur models to apply to each of the regions based on the depth information. The deblur models may include a single stream approach involving a single sensor and a dual stream approach involving a plurality of sensors. In some examples, if the depth value associated with a region of interest is high, then the computing system may select the dual stream approach rather than the single stream approach, as the computing system may be unable to obtain all the information necessary to deblur the region through use of a single sensor. Each sensor in the plurality of sensors may be located on the computing system or remotely located such that the images are sent to the computing system for processing.

The computing system may then apply the deblur model to the image to determine a deblurred image. The deblurred image may include the at least one pixel area identified to contain a region of interest in the image such that the at least one pixel area is deblurred based on the depth information. The computing system may then display the deblurred image.

In some examples, the methods described herein may apply to images captured and stored in the computing system and/or images displayed on the computing system. For example, the methods described herein may be applied to an image after the computing system receives an indication to capture an image. Additionally and/or alternatively, the methods described herein may be applied to images displayed on the computing system as a viewfinder, without the computing system receiving an indication to capture an image.

Applying various degrees of deblurring based on determined depth information may allow for the deblurring of a particular region to be controlled, such that areas are not oversharpened. For example, in an image with a person in front of another person, applying the method disclosed herein may allow for the person in front to be deblurred more than the other person, which may result in the post-processing of the image being less evident and in an improvement in user experience. Further, the methods described herein may facilitate real-time image analysis, so that the computing system may receive a stream of images and that the deblurred images may be output as part of a viewfinder application.

### II. Example Systems and Methods

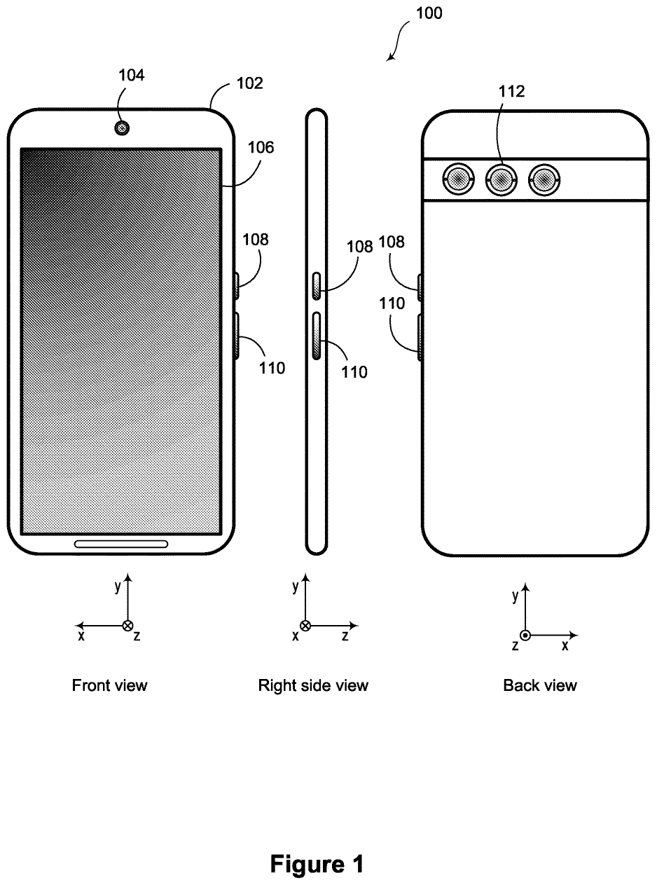

FIG. 1 illustrates an example computing device 100. Computing device 100 is shown in the form factor of a mobile phone. However, computing device 100 may be alternatively implemented as a laptop computer, a tablet computer, and/or a wearable computing device, among other possibilities. Computing device 100 may include various elements, such as body 102, display 106, and buttons 108 and 110. Computing device 100 may further include one or more cameras, such as front-facing camera 104 and at least one rear-facing camera 112. In examples with multiple rear-facing cameras such as illustrated in FIG. 1, each of the rear-facing cameras may have a different field of view. For example, the rear facing cameras may include a wide angle camera, a main camera, and a telephoto camera. The wide angle camera may capture a larger portion of the environment compared to the main camera and the telephoto camera, and the telephoto camera may capture more detailed images of a smaller portion of the environment compared to the main camera and the wide angle camera. In some examples, front-facing camera 104, rear-facing camera 112, and/or one or more other cameras may be remote from computing device 100. Computing device 100 may communicate with front-facing camera 104, rear-facing camera 112, and/or the one or more other cameras wirelessly rather than through a physical (e.g., wired) connection as shown here.

Front-facing camera 104 may be positioned on a side of body 102 typically facing a user while in operation (e.g., on the same side as display 106). Rear-facing camera 112 may be positioned on a side of body 102 opposite front-facing camera 104. Referring to the cameras as front and rear facing is arbitrary, and computing device 100 may include multiple cameras positioned on various sides of body 102.

Display 106 could represent a cathode ray tube (CRT) display, a light emitting diode (LED) display, a liquid crystal (LCD) display, a plasma display, an organic light emitting diode (OLED) display, or any other type of display known in the art. In some examples, display 106 may display a digital representation of the current image being captured by front-facing camera 104 and/or rear-facing camera 112, an image that could be captured by one or more of these cameras, an image that was recently captured by one or more of these cameras, and/or a modified version of one or more of these images. Thus, display 106 may serve as a viewfinder for the cameras. Display 106 may also support touchscreen functions that may be able to adjust the settings and/or configuration of one or more aspects of computing device 100.

Front-facing camera 104 may include an image sensor and associated optical elements such as lenses. Front-facing camera 104 may offer zoom capabilities or could have a fixed focal length. In other examples, interchangeable lenses could be used with front-facing camera 104. Front-facing camera 104 may have a variable mechanical aperture and a mechanical and/or electronic shutter. Front-facing camera 104 also could be configured to capture still images, video images, or both. Further, front-facing camera 104 could represent, for example, a monoscopic, stereoscopic, or multiscopic camera. Rear-facing camera 112 may be similarly or differently arranged. Additionally, one or more of front-facing camera 104 and/or rear-facing camera 112 may be an array of one or more cameras.

One or more of front-facing camera 104 and/or rear-facing camera 112 may include or be associated with an illumination component that provides a light field to illuminate a target object. For instance, an illumination component could provide flash or constant illumination of the target object. An illumination component could also be configured to provide a light field that includes one or more of structured light, polarized light, and light with specific spectral content. Other types of light fields known and used to recover three-dimensional (3D) models from an object are possible within the context of the examples herein.

Computing device 100 may also include an ambient light sensor that may continuously or from time to time determine the ambient brightness of a scene that cameras 104 and/or 112 can capture. In some implementations, the ambient light sensor can be used to adjust the display brightness of display 106. Additionally, the ambient light sensor may be used to determine an exposure length of one or more of cameras 104 or 112, or to help in this determination.

Computing device 100 could be configured to use display 106 and front-facing camera 104 and/or rear-facing camera 112 to capture images of a target object. The captured images could be a plurality of still images or a video stream. The image capture could be triggered by activating button 108, pressing a softkey on display 106, or by some other mechanism. Depending upon the implementation, the images could be captured automatically at a specific time interval, for example, upon pressing button 108, upon appropriate lighting conditions of the target object, upon moving computing device 100 a predetermined distance, or according to a predetermined capture schedule.

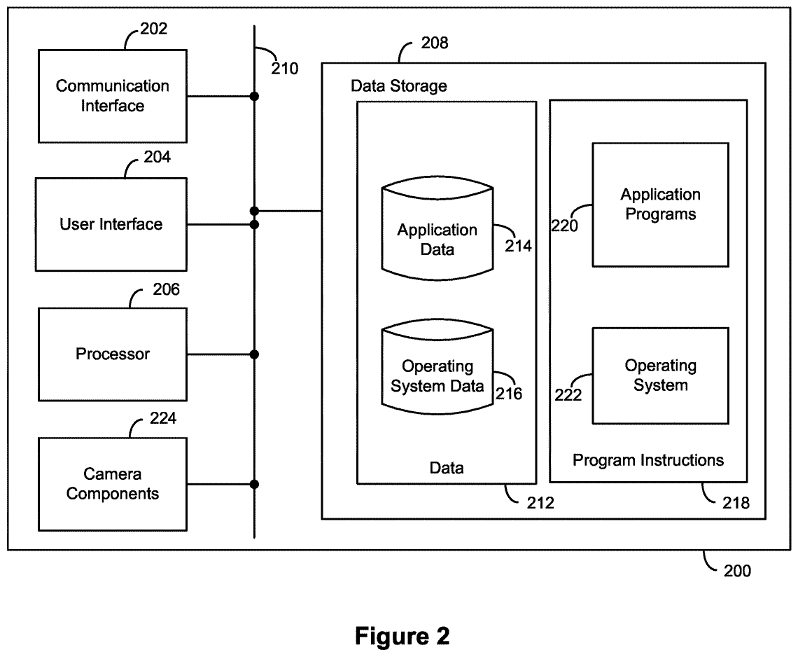

FIG. 2 is a simplified block diagram showing some of the components of an example computing system 200. By way of example and without limitation, computing system 200 may be a cellular mobile telephone (e.g., a smartphone), a computer (such as a desktop, notebook, tablet, server, or handheld computer), a home automation component, a digital video recorder (DVR), a digital television, a remote control, a wearable computing device, a gaming console, a robotic device, a vehicle, or some other type of device. Computing system 200 may represent, for example, aspects of computing device 100.

As shown in FIG. 2, computing system 200 may include communication interface 202, user interface 204, processor 206, data storage 208, and camera components 224, all of which may be communicatively linked together by a system bus, network, or other connection mechanism 210. Computing system 200 may be equipped with at least some image capture and/or image processing capabilities. It should be understood that computing system 200 may represent a physical image processing system, a particular physical hardware platform on which an image sensing and/or processing application operates in software, or other combinations of hardware and software that are configured to carry out image capture and/or processing functions.

Communication interface 202 may allow computing system 200 to communicate, using analog or digital modulation, with other devices, access networks, and/or transport networks. Thus, communication interface 202 may facilitate circuit-switched and/or packet-switched communication, such as plain old telephone service (POTS) communication and/or Internet protocol (IP) or other packetized communication. For instance, communication interface 202 may include a chipset and antenna arranged for wireless communication with a radio access network or an access point. Also, communication interface 202 may take the form of or include a wireline interface, such as an Ethernet, Universal Serial Bus (USB), or High-Definition Multimedia Interface (HDMI) port, among other possibilities. Communication interface 202 may also take the form of or include a wireless interface, such as a Wi-Fi, BLUETOOTH®, global positioning system (GPS), or wide-area wireless interface (e.g., WiMAX or 3GPP Long-Term Evolution (LTE)), among other possibilities. However, other forms of physical layer interfaces and other types of standard or proprietary communication protocols may be used over communication interface 202. Furthermore, communication interface 202 may comprise multiple physical communication interfaces (e.g., a Wi-Fi interface, a BLUETOOTH® interface, and a wide-area wireless interface).

User interface 204 may function to allow computing system 200 to interact with a human or non-human user, such as to receive input from a user and to provide output to the user. Thus, user interface 204 may include input components such as a keypad, keyboard, touch-sensitive panel, computer mouse, trackball, joystick, microphone, and so on. User interface 204 may also include one or more output components such as a display screen, which, for example, may be combined with a touch-sensitive panel. The display screen may be based on CRT, LCD, LED, and/or OLED technologies, or other technologies now known or later developed. User interface 204 may also be configured to generate audible output(s), via a speaker, speaker jack, audio output port, audio output device, earphones, and/or other similar devices. User interface 204 may also be configured to receive and/or capture audible utterance(s), noise(s), and/or signal(s) by way of a microphone and/or other similar devices.

In some examples, user interface 204 may include a display that serves as a viewfinder for still camera and/or video camera functions supported by computing system 200. Additionally, user interface 204 may include one or more buttons, switches, knobs, and/or dials that facilitate the configuration and focusing of a camera function and the capturing of images. It may be possible that some or all of these buttons, switches, knobs, and/or dials are implemented by way of a presence-sensitive panel.

Processor 206 may comprise one or more general purpose processors-e.g., microprocessors-and/or one or more special purpose processors-e.g., digital signal processors (DSPs), graphics processing units (GPUs), floating point units (FPUs), network processors, or application-specific integrated circuits (ASICs). In some instances, special purpose processors may be capable of image processing, image alignment, and merging images, among other possibilities. Data storage 208 may include one or more volatile and/or non-volatile storage components, such as magnetic, optical, flash, or organic storage, and may be integrated in whole or in part with processor 206. Data storage 208 may include removable and/or non-removable components.

Processor 206 may be capable of executing program instructions 218 (e.g., compiled or non-compiled program logic and/or machine code) stored in data storage 208 to carry out the various functions described herein. Therefore, data storage 208 may include a non-transitory computer-readable medium, having stored thereon program instructions that, upon execution by computing system 200, cause computing system 200 to carry out any of the methods, processes, or operations disclosed in this specification and/or the accompanying drawings. The execution of program instructions 218 by processor 206 may result in processor 206 using data 212.

By way of example, program instructions 218 may include an operating system 222 (e.g., an operating system kernel, device driver(s), and/or other modules) and one or more application programs 220 (e.g., camera functions, address book, email, web browsing, social networking, audio-to-text functions, text translation functions, and/or gaming applications) installed on computing system 200. Similarly, data 212 may include operating system data 216 and application data 214. Operating system data 216 may be accessible primarily to operating system 222, and application data 214 may be accessible primarily to one or more of application programs 220. Application data 214 may be arranged in a file system that is visible to or hidden from a user of computing system 200.

Application programs 220 may communicate with operating system 222 through one or more application programming interfaces (APIs). These APIs may facilitate, for instance, application programs 220 reading and/or writing application data 214, transmitting or receiving information via communication interface 202, receiving and/or displaying information on user interface 204, and so on.

In some cases, application programs 220 may be referred to as “apps” for short. Additionally, application programs 220 may be downloadable to computing system 200 through one or more online application stores or application markets. However, application programs can also be installed on computing system 200 in other ways, such as via a web browser or through a physical interface (e.g., a USB port) on computing system 200.

Camera components 224 may include, but are not limited to, an aperture, shutter, recording surface (e.g., photographic film and/or an image sensor), lens, shutter button, infrared projectors, and/or visible-light projectors. Camera components 224 may include components configured for capturing of images in the visible-light spectrum (e.g., electromagnetic radiation having a wavelength of 380-700 nanometers) and/or components configured for capturing of images in the infrared light spectrum (e.g., electromagnetic radiation having a wavelength of 701 nanometers-1 millimeter), among other possibilities. Camera components 224 may be controlled at least in part by software executed by processor 206.

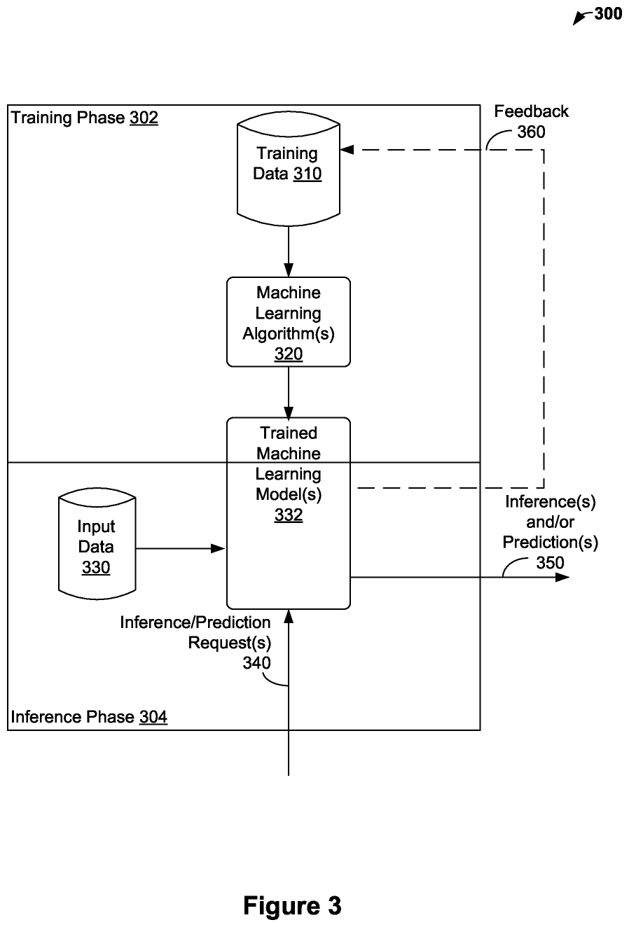

FIG. 3 shows diagram 300 illustrating a training phase 302 and an inference phase 304 of trained machine learning model(s) 332, in accordance with example embodiments. Some machine learning techniques involve training one or more machine learning algorithms on an input set of training data to recognize patterns in the training data and provide output inferences and/or predictions about (patterns in the) training data. The resulting trained machine learning algorithm can be termed as a trained machine learning model. For example, FIG. 3 shows training phase 302 where one or more machine learning algorithms 320 are being trained on training data 310 to become trained machine learning model 332. Producing trained machine learning model(s) 332 during training phase 302 may involve determining one or more hyperparameters, such as one or more stride values for one or more layers of a machine learning model as described herein. Then, during inference phase 304, trained machine learning model 332 can receive input data 330 and one or more inference/prediction requests 340 (perhaps as part of input data 330) and responsively provide as an output one or more inferences and/or predictions 350. The one or more inferences and/or predictions 350 may be based in part on one or more learned hyperparameters, such as one or more learned stride values for one or more layers of a machine learning model as described herein As such, trained machine learning model(s) 332 can include one or more models of one or more machine learning algorithms 320. Machine learning algorithm(s) 320 may include, but are not limited to: an artificial neural network (e.g., a herein-described convolutional neural networks, a recurrent neural network, a Bayesian network, a hidden Markov model, a Markov decision process, a logistic regression function, a support vector machine, a suitable statistical machine learning algorithm, and/or a heuristic machine learning system). Machine learning algorithm(s) 120 may be supervised or unsupervised, and may implement any suitable combination of online and offline learning.

In some examples, machine learning algorithm(s) 320 and/or trained machine learning model(s) 332 can be accelerated using on-device coprocessors, such as graphic processing units (GPUs), tensor processing units (TPUs), digital signal processors (DSPs), and/or application specific integrated circuits (ASICs). Such on-device coprocessors can be used to speed up machine learning algorithm(s) 320 and/or trained machine learning model(s) 332. In some examples, trained machine learning model(s) 332 can be trained, reside and execute to provide inferences on a particular computing device, and/or otherwise can make inferences for the particular computing device.

During training phase 302, machine learning algorithm(s) 320 can be trained by providing at least training data 310 as training input using unsupervised, supervised, semi-supervised, and/or reinforcement learning techniques. Unsupervised learning involves providing a portion (or all) of training data 310 to machine learning algorithm(s) 320 and machine learning algorithm(s) 320 determining one or more output inferences based on the provided portion (or all) of training data 310. Supervised learning involves providing a portion of training data 310 to machine learning algorithm(s) 320, with machine learning algorithm(s) 320 determining one or more output inferences based on the provided portion of training data 310, and the output inference(s) are either accepted or corrected based on correct results associated with training data 310. In some examples, supervised learning of machine learning algorithm(s) 320 can be governed by a set of rules and/or a set of labels for the training input, and the set of rules and/or set of labels may be used to correct inferences of machine learning algorithm(s) 320.

Semi-supervised learning involves having correct results for part, but not all, of training data 310. During semi-supervised learning, supervised learning is used for a portion of training data 310 having correct results, and unsupervised learning is used for a portion of training data 310 not having correct results.

Reinforcement learning involves machine learning algorithm(s) 320 receiving a reward signal regarding a prior inference, where the reward signal can be a numerical value. During reinforcement learning, machine learning algorithm(s) 320 can output an inference and receive a reward signal in response, where machine learning algorithm(s) 320 are configured to try to maximize the numerical value of the reward signal. In some examples, reinforcement learning also utilizes a value function that provides a numerical value representing an expected total of the numerical values provided by the reward signal over time. In some examples, machine learning algorithm(s) 320 and/or trained machine learning model(s) 332 can be trained using other machine learning techniques, including but not limited to, incremental learning and curriculum learning.

In some examples, machine learning algorithm(s) 320 and/or trained machine learning model(s) 332 can use transfer learning techniques. For example, transfer learning techniques can involve trained machine learning model(s) 332 being pre-trained on one set of data and additionally trained using training data 310. More particularly, machine learning algorithm(s) 320 can be pre-trained on data from one or more computing devices and a resulting trained machine learning model provided to computing device CD1, where CD1 is intended to execute the trained machine learning model during inference phase 304. Then, during training phase 302, the pre-trained machine learning model can be additionally trained using training data 310. This further training of the machine learning algorithm(s) 320 and/or the pre-trained machine learning model using training data 310 of CD1's data can be performed using either supervised or unsupervised learning. Once machine learning algorithm(s) 320 and/or the pre-trained machine learning model has been trained on at least training data 310, training phase 302 can be completed. The trained resulting machine learning model can be utilized as at least one of trained machine learning model(s) 332.

In particular, once training phase 302 has been completed, trained machine learning model(s) 332 can be provided to a computing device, if not already on the computing device. Inference phase 304 can begin after trained machine learning model(s) 332 are provided to computing device CD1.

During inference phase 304, trained machine learning model(s) 332 can receive input data 330 and generate and output one or more corresponding inferences and/or predictions 350 about input data 330. As such, input data 330 can be used as an input to trained machine learning model(s) 332 for providing corresponding inference(s) and/or prediction(s) 350. For example, trained machine learning model(s) 332 can generate inference(s) and/or prediction(s) 350 in response to one or more inference/prediction requests 340. In some examples, trained machine learning model(s) 332 can be executed by a portion of other software. For example, trained machine learning model(s) 332 can be executed by an inference or prediction daemon to be readily available to provide inferences and/or predictions upon request. Input data 330 can include data from computing device CD1 executing trained machine learning model(s) 332 and/or input data from one or more computing devices other than CD1.

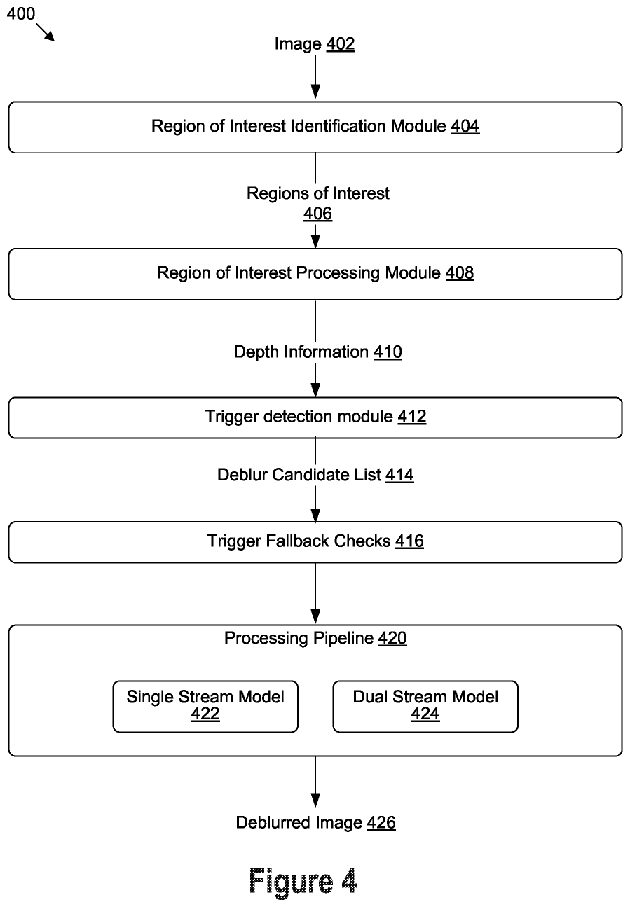

FIG. 4 is block diagram 400, in accordance with example embodiments. Block diagram 400 illustrates a deblurring process. Block diagram 400 may be carried out by a computing system, including, for example, a mobile device, a server, a laptop, among other examples. Each of the blocks of block diagram 400 may be carried out by a single computing system or multiple computing systems.

As illustrated in block diagram 400, a computing system may apply region of interest identification module 404 to an image, e.g., image 402, to determine at least one pixel area identified to contain a region of interest within the image. As mentioned above, these pixel areas identified to contain a region of interest may include a person, the person's face, text, among others, perhaps depending on the subject(s) in the environment and the position of the subject(s) as portrayed in the image. For example, for an image with a person standing in front of a store with a sign, the pixel area containing the person may be identified as a region of interest and the pixel area containing the sign may be a region of interest. For an image with two people, one standing in front of the other, pixel areas containing either or both of the people and/or the faces of the people may be identified as regions of interest.

In some examples, the computing system may identify at least one pixel area containing a region of interest based on applying a machine learning model as part of region of interest identification module 404. The machine learning model may take an image as an input and output an indication of one or more pixel areas in the image that may contain a region of interest. The machine learning model may also take additional inputs (e.g., other sensor data) and output additional information.

After having determined regions of interest 406, the computing system may apply region of interest processing module 408 to determine depth information 410. Applying region of interest processing module 408 may involve applying a machine learning model, which may take sensor data as an input and output depth information 410. In some examples, the sensor data may include a plurality of images, including image 402 and/or regions of interest 406. Each image of these plurality of images may have a different perspective of the environment, perhaps due to being captured by sensors having different fields of views. For example, the image the computing system is deblurring may be collected by a first sensor directly facing a person's face. The computing system may receive another image from a second sensor slightly underneath the first sensor and thereby have a perspective of slightly underneath the person's face. The computing system may use both of these images to determine depth information 410 for image 402. Additionally and/or alternatively, the computing system may use additional sensor data (e.g., LIDAR sensor data) to determine depth information 410 for image 402.

In some examples, depth information 410 may include an identifier for each region of interest 406 and an associated depth value. The computing system may randomly generate and assign an identifier such that each region of interest has a different identifier as part of applying region of interest processing module 408, which may output a depth information 410 that includes a depth value and the randomly assigned identifier. In some examples, depth information 410 may be a hashmap between an identifier for a region of interest 406 and the associated depth value.

The computing system may then input depth information 410 into trigger detection module 412, which may output deblur candidate list 414. As part of trigger detection module 412, the computing system may determine whether each pixel area in depth information 410 has an associated depth value that is at least a threshold value. The pixel areas that exceed the threshold value may be output in deblur candidate list 414. Additionally and/or alternatively, the computing system may store a threshold number of pixel areas to deblur per image, and the computing system may select one or more pixel areas up to the threshold number of pixel areas to include in deblur candidate list 414. In some examples, the computing system may determine which pixel areas are most blurred and/or which pixel areas are most likely to benefit from deblurring, and the computing system may include these pixel areas in deblur candidate list 414. Selecting pixel areas to deblur in an image may facilitate efficient usage of processing power of the computing system, as selecting pixel areas may allow for the computing system to deblur fewer areas while still efficiently improving user experience.

In some examples, the computing system may further ensure that image 402 and/or the pixel areas in deblur candidate list 414 include areas where deblurring would likely be effective by applying trigger fallback checks 416. Trigger fallback checks 416 may include checks that are based on processing constraints. For example, as part of one check, the computing system may verify that the brightness of the image and/or of the pixel area is a particular threshold brightness, because if the area is too dark, the computing system may have inaccurately determined that the area includes a region of interest and/or may be unable to determine an accurate depth estimate. The computing system may also verify that a zoom ratio of the image is below a threshold zoom ratio, as the computing system may be unable to deblur an area that is excessively zoomed in and/or may be unable to determine an accurate depth measurement. Additional processing constraints are also possible.

The computing system may execute processing pipeline 420, which may include one or more deblur models, including, for example, single stream model 422 and dual stream model 424. Additional and/or alternative deblurring models may also be possible. The computing system may determine which deblur model to apply based on the depth measurements of the pixel areas, and the computing system may apply a different deblur model to each pixel area in the image.

For example, if the subject in the environment and portrayed in the pixel area is determined to be more than a threshold distance away, then the computing system may apply dual stream model 424 and otherwise, the computing system may apply single stream model 422.

Applying dual stream model 424 may involve the computing system activating one or more additional sensors, such that the computing device may capture a plurality of images using the sensor used to capture image 402 and the one or more additional sensors. Each of the additional sensors may capture data at a different field of view than the field of view of image 402, which may help facilitate in determining a deblurred pixel area. In some examples, dual stream model 424 may be used when the subject as portrayed by the pixel area is particularly blurry, as the computing system may be unable to deblur the pixel area using a single image. Applying dual stream model 424 may involve applying a machine learning model to the two images and/or an area in each image that includes the subject to deblur. The machine learning model may output a deblurred image and/or a deblurred area. If the machine learning model outputs a deblurred area, the computing system may overlay the deblurred area over the blurred area in the image 402 or otherwise replace the blurred area in the image 402 with the determined deblurred area.

Applying single stream model 422 may involve the computing system modifying image 402. by putting the pixel area and/or the image through a machine learning model to determine the deblurred pixel area. The machine learning model may output a deblurred image, and/or a deblurred area. If the machine learning model outputs a deblurred area, the computing system may overlay the deblurred area over the blurred area in the image 402 or otherwise replace the blurred area in the image 402 with the determined deblurred area. Additional options for deblurring the image are also possible.

Based on the deblurred pixel area, the computing system may determine deblurred image 426. In particular, the computing system may replace one or more portions of image 402 with the deblurred pixel areas. Additionally and/or alternatively, single stream model 422 and/or dual stream model 424 may output deblurred image 426. After having determined deblurred image 426, the computing system may send deblurred image 426 to a server for storage and/or display deblurred image 426 on a screen of the computing system.

In some examples, the computing system may perform a subset of the blocks shown in block diagram 400. For example, the computing system may determine depth information 410 and proceed to processing pipeline 420 with deblurring of each of the pixel areas included in depth information 410, without carrying out trigger detection module 412 or trigger fallback checks 416. Additionally and/or alternatively, the computing system may carry out additional steps in addition to those shown in block diagram 400 to determine deblurred image 426. For example, the computing system may execute a process to determine whether each pixel area included in regions of interest 406, depth information 410 and/or deblur candidate list 414 contains optical blur (e.g., an out of focus subject), motion blur (e.g., moving lens or object), both, or neither. If the computing system determines that a pixel area contains both, then the computing system may indicate that deblurring motion blur is to be prioritized over deblurring optical blur. In some examples, determining depth information 410 may be in response to determining that the blur of each pixel area in regions of interest 406 is primarily caused by optical blur instead of motion blur. For example, being primarily caused by optical blur instead of motion blur may be determining that the blur of the respective pixel area is more than 50% optical blur instead of motion blur.

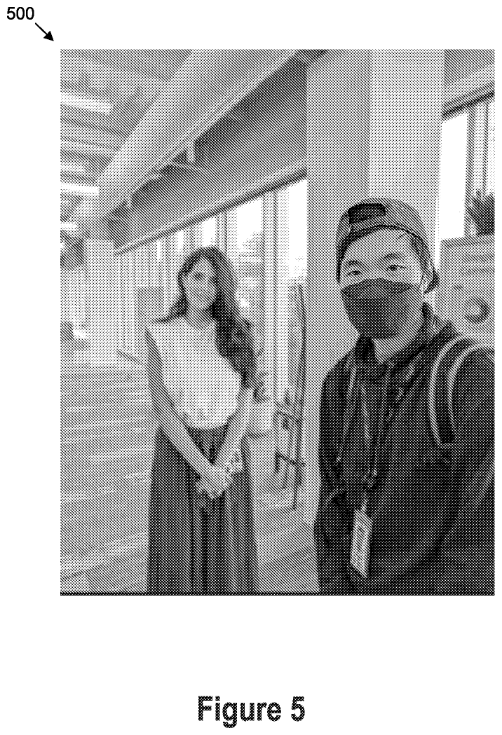

As mentioned above, a computing system may apply the deblurring process shown in block diagram 400 to an image received from a sensor. FIG. 5 is image 500, in accordance with example embodiments. A computing system may apply the deblurring process described in block diagram 400 to image 500, as described below in an example implementation.

As mentioned above, a computing system may receive an image, such as image 500, from one or more sensors on the computing system and/or one or more other sensors communicating with the computing system. The computing system may receive image 500 as a captured image, and the computing system may undertake the process disclosed herein to display and/or store an image that has been deblurred. Additionally and/or alternatively, the computing system may receive image 500 as part of a stream of a plurality of images, and the computing system may undertake the process disclosed herein to display the stream of images, perhaps as part of a viewfinder application on the computing system.

The computing system may determine one or more pixel areas in image 500 such that each pixel area contains a region of interest. In some examples, the computing system may input image 500 into a machine learning model to determine the pixel areas that contain regions of interest. The machine learning model may identify pixel areas that contain faces, signage, words, and/or other pixel areas that may contain regions of interest.

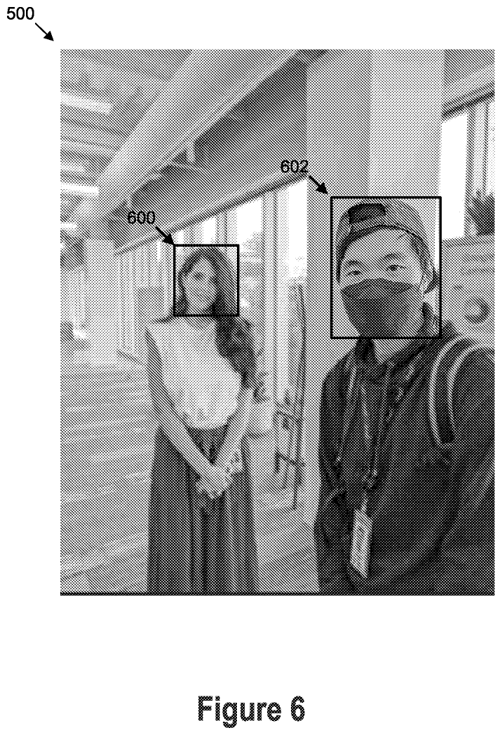

FIG. 6 is image 500 with indicated regions of interest, in accordance with example embodiments. As shown in image 500, the computing system may have identified pixel area 600 as containing a region of interest and pixel area 602 as containing another region of interest.

Based on identified pixel areas 600 and 602 and image 500, the computing system may determine depth information, perhaps by inputting pixel areas 600 and 602, image 500, and/or other sensor data into a machine learning model or other algorithm. The depth information may include a depth value for the image that represents an estimation of the distance from the sensor to the subject portrayed in the image. The depth information may also include an identifier, which may be randomly assigned.

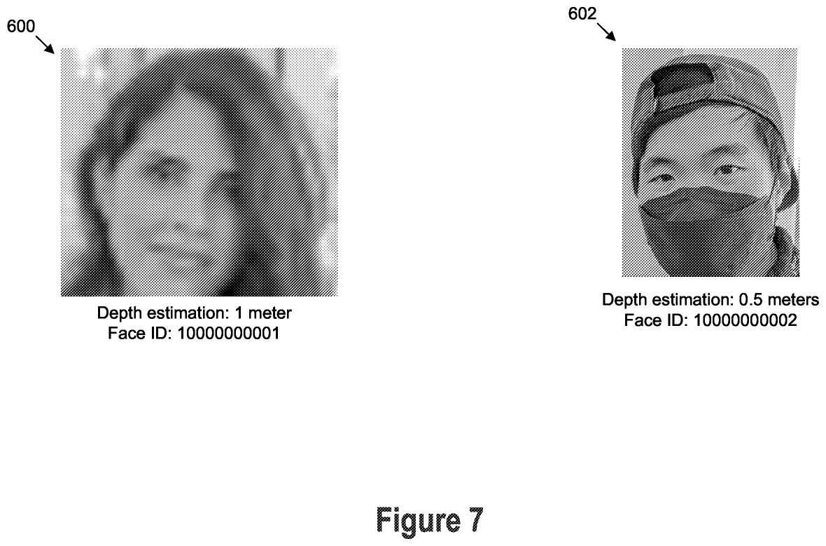

For example, FIG. 7 illustrates pixel area 600 and 602 with regions of interests, in accordance with example embodiments. Based on pixel area 600, pixel area 602, image 500, and/or additional sensor data, the computing system may determine that the person's face in pixel area 600 is about a meter away from the sensor. Additionally and/or alternatively, the computing system may determine that the person's face in pixel area 602 is about a half a meter away from the sensor. The computing system may also assign identifiers to the pixel areas, including, for example, identifier 10000000001 for pixel area 600 and identifier 10000000002 for pixel area 602.

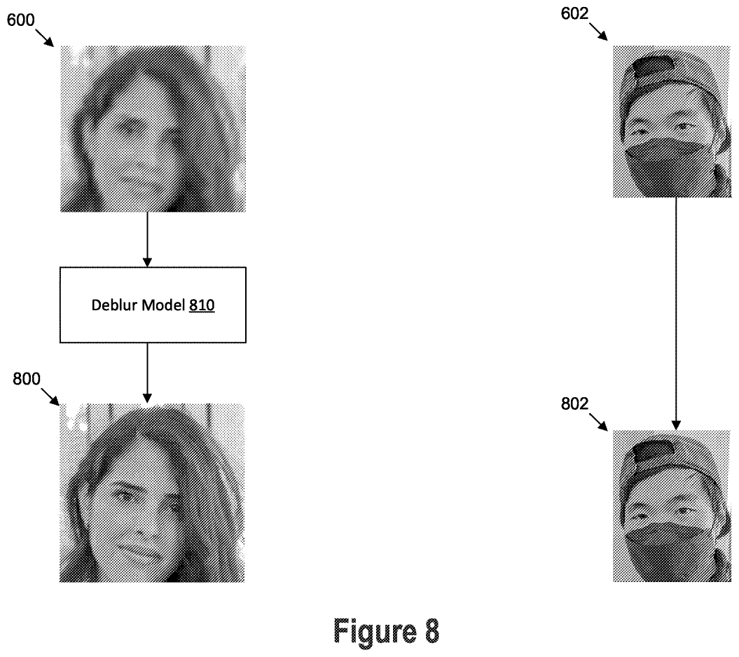

FIG. 8 illustrates pixel areas before and after processing, in accordance with example embodiments. As mentioned above, the computing system may select a deblur model from a plurality of deblur areas to apply to each pixel area based on the depth measurements. For example, for pixel area 600, the computing system may select to apply deblur model 810 to obtain deblurred area 800.

During this process, the computing system may also verify that deblurring should apply to the pixel area through applying a list of verifications. For example, the computing system may determine that deblurring should not be applied to pixel area 602, perhaps because the depth information associated with pixel area 602 indicates that the subject portrayed in pixel area 602 is not far away enough for deblurring to apply. Therefore, pixel area 602 may remain unprocessed in pixel area 802. The computing system may also verify other factors, including, for example, that the image and/or pixel area are not excessively dark, that the image and/or pixel area are not excessively bright, that the image and/or pixel area is not excessively zoomed in, that the pixel area is not excessively large and/or small, among other factors. In some examples, the computing system may determine one or more values for each of these factors and evaluate these values against threshold values to determine whether the computing system should apply deblurring to the image and/or pixel area.

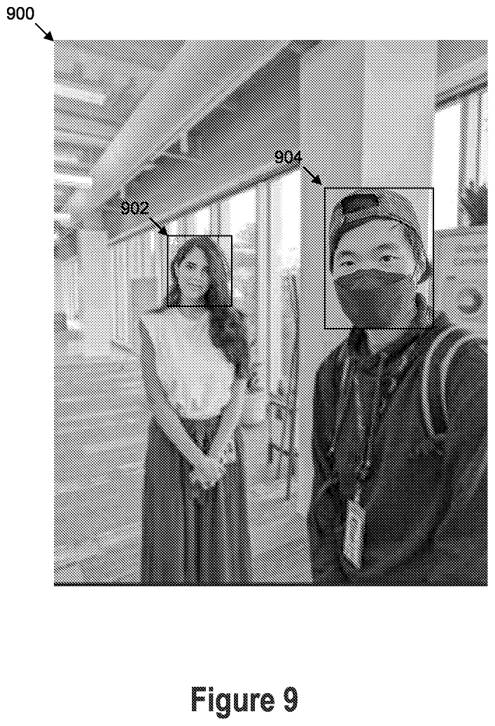

By applying the deblurring model(s) to the image and/or pixel area, the computing system may determine the deblurred image. FIG. 9 illustrates deblurred image 900 with indicated regions of interests, in accordance with example embodiments. The computing system may output deblurred image 900 through a display of the computing system. Additionally and/or alternatively, the computing system may store deblurred image 900 for further processing (e.g., facial recognition). Other operations are also possible.

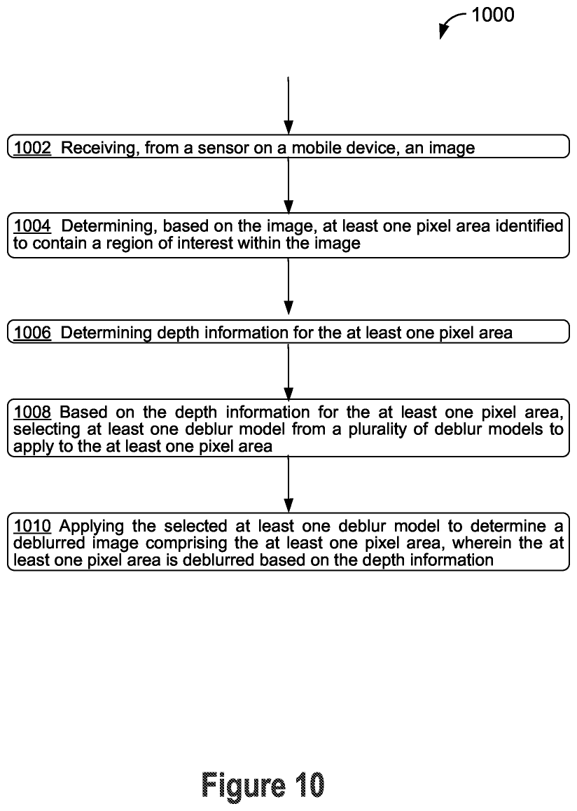

FIG. 10 is a block diagram of a method, in accordance with example embodiments. Blocks 1002, 1004, 1006, 1008, and 1010 may collectively be referred to as method 10. In some examples, method 1000 may be executed by one or more computing systems (e.g., computing system 200 of FIG. 2) and/or one or more processors (e.g., processor 206 of FIG. 2). In further examples, method 1000 may be carried out on a computing device, such as computing device 100 of FIG. 1. Execution of method 1000 may involve a computing device or server device remote from computing device 100. Other computing devices may also be used in the performance of method 1000. The one or more computing devices and/or one or more computing systems used in the execution of method 1000 may be collectively referred to herein as a “computing system.”

Those skilled in the art will understand that the block diagram of FIG. 10 illustrates functionality and operation of certain implementations of the present disclosure. In this regard, each block of the block diagram may represent a module, a segment, or a portion of program code, which includes one or more instructions executable by one or more processors for implementing specific logical functions or steps in the process. The program code may be stored on any type of computer readable medium, for example, such as a storage device including a disk or hard drive.

In addition, each block may represent circuitry that is wired to perform the specific logical functions in the process. Alternative implementations are included within the scope of the example implementations of the present application in which functions may be executed out of order from that shown or discussed, including substantially concurrent or in reverse order, depending on the functionality involved, as would be understood by those reasonably skilled in the art.

At block 1002, method 1000 includes receiving, from a sensor, an image.

At block 1004, method 1000 includes determining, based on the image, at least one pixel area identified to contain a region of interest within the image.

At block 1006, method 1000 includes determining depth information for the at least one pixel area.

At block 1008, method 1000 includes based on the depth information for the at least one pixel area, selecting at least one deblur model from a plurality of deblur models to apply to the at least one pixel area.

At block 1010, method 1000 includes applying the selected at least one deblur model to determine a deblurred image comprising the at least one pixel area, where the at least one pixel area is deblurred based on the depth information.

In some examples, the plurality of deblur models comprises a single stream model and a dual stream model.

In some examples, the selected at least one deblur model is a single stream model, where applying the selected at least one deblur model to determine the deblurred image comprises using data captured by a single camera to determine the deblurred image.

In some examples, the selected at least one deblur model is a dual stream model, where applying the selected at least one deblur model to determine the deblurred image comprises using data captured by a plurality of cameras to determine the deblurred image.

In some examples, determining the depth information for the at least one pixel area is based on applying a region of interest processing module that takes as an input an indication of the at least one pixel area and outputs depth information for each of the at least one pixel area.

In some examples, the depth information output by the region of interest processing module comprises a depth value for each of the at least one pixel area and an identifier associated with each of the at least one pixel area.

In some examples, selecting the at least one deblur model comprises selecting a deblur model for each of the at least one pixel area.

In some examples, the depth information comprises a depth value for each of the at least one pixel area and an identifier associated with each of the at least one pixel area, where method 1000 further comprises applying, based on the depth information, a trigger detection module that outputs an indication to deblur each of the at least one pixel area, where selecting the at least one deblur model is based on an output of the trigger detection module.

In some examples, applying the trigger detection module that outputs an indication to deblur each of the at least one pixel area comprises determining that each of the at least one pixel area is associated with at least a threshold depth measurement.

In some examples, the indication comprises a list of each of the at least one pixel area to deblur.

In some examples, the at least one pixel area includes a first pixel area and a second pixel area, where the depth information indicates a high depth value for the first pixel area and a low depth value for the second pixel area, where the at least one pixel area is deblurred less than the second pixel area.

In some examples, method 1000 further comprises verifying, based on the image, whether to apply the deblur model.

In some examples, verifying whether to apply the at least one deblur model comprises determining that a brightness estimate of the image is above a threshold amount.

In some examples, verifying whether to apply the at least one deblur model comprises determining that the at least one pixel area is below a threshold area of the image.

In some examples, verifying whether to apply the at least one deblur model comprises determining a zoom ratio of the image, and determining that the zoom ratio of the image is below a threshold zoom ratio.

In some examples, method 1000 further comprises determining, for each respective pixel area of the at least one pixel area, whether blur in the respective pixel area is primarily caused by optical blur instead of motion blur, where determining the depth information for the respective pixel area is based on the determination that the blur is primarily caused by optical blur instead of motion blur.

In some examples, method 1000 further comprises displaying the determined deblurred image.

In some examples, the region of interest depicts a person or a face of the person.

### III. Conclusion

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. In the figures, similar symbols typically identify similar components, unless context dictates otherwise. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information may correspond to circuitry that can be configured to perform the specific logical functions of a herein-described method or technique. Alternatively or additionally, a block that represents a processing of information may correspond to a module, a segment, or a portion of program code (including related data). The program code may include one or more instructions executable by a processor for implementing specific logical operations or actions in the method or technique. The program code and/or related data may be stored on any type of computer readable medium such as a storage device including random access memory (RAM), a disk drive, a solid state drive, or another storage medium.

The computer readable medium may also include non-transitory computer readable media such as computer readable media that store data for short periods of time like register memory, processor cache, and RAM. The computer readable media may also include non-transitory computer readable media that store program code and/or data for longer periods of time. Thus, the computer readable media may include secondary or persistent long term storage, like read only memory (ROM), optical or magnetic disks, solid state drives, compact-disc read only memory (CD-ROM), for example. The computer readable media may also be any other volatile or non-volatile storage systems. A computer readable medium may be considered a computer readable storage medium, for example, or a tangible storage device.

Moreover, a step or block that represents one or more information transmissions may correspond to information transmissions between software and/or hardware modules in the same physical device. However, other information transmissions may be between software modules and/or hardware modules in different physical devices.

The particular arrangements shown in the figures should not be viewed as limiting. It should be understood that other embodiments can include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for the purpose of illustration and are not intended to be limiting, with the true scope being indicated by the following claims.

What is claimed is:

1. A method comprising:
receiving, from a sensor, an image;
determining, based on the image, at least one pixel area identified to contain a region of interest within the image;
determining depth information for the at least one pixel area;
based on the depth information for the at least one pixel area, selecting at least one deblur model from a plurality of deblur models to apply to the at least one pixel area; and
applying the selected at least one deblur model to determine a deblurred image comprising the at least one pixel area, wherein the at least one pixel area is deblurred based on the depth information.

2. The method of claim 1, wherein the plurality of deblur models comprises a single stream model and a dual stream model.

3. The method of claim 1, wherein the selected at least one deblur model is a single stream model, wherein applying the selected at least one deblur model to determine the deblurred image comprises using data captured by a single camera to determine the deblurred image.

4. The method of claim 1, wherein the selected at least one deblur model is a dual stream model, wherein applying the selected at least one deblur model to determine the deblurred image comprises using data captured by a plurality of cameras to determine the deblurred image.

5. The method of claim 1, wherein determining the depth information for the at least one pixel area is based on applying a region of interest processing module that takes as an input an indication of the at least one pixel area and outputs depth information for each of the at least one pixel area.

6. The method of claim 5, wherein the depth information output by the region of interest processing module comprises a depth value for each of the at least one pixel area and an identifier associated with each of the at least one pixel area.

7. The method of claim 1, wherein selecting the at least one deblur model comprises selecting a deblur model for each of the at least one pixel area.

8. The method of claim 1, wherein the depth information comprises a depth value for each of the at least one pixel area and an identifier associated with each of the at least one pixel area, wherein the method further comprises:
applying, based on the depth information, a trigger detection module that outputs an indication to deblur each of the at least one pixel area, wherein selecting the at least one deblur model is based on an output of the trigger detection module.

9. The method of claim 8, wherein applying the trigger detection module that outputs an indication to deblur each of the at least one pixel area comprises determining that each of the at least one pixel area is associated with at least a threshold depth measurement.

10. The method of claim 8, wherein the indication comprises a list of each of the at least one pixel area to deblur.

11. The method of claim 1, wherein the at least one pixel area includes a first pixel area and a second pixel area, wherein the depth information indicates a high depth value for the first pixel area and a low depth value for the second pixel area, wherein the at least one pixel area is deblurred less than the second pixel area.

12. The method of claim 1, further comprising:
verifying, based on the image, whether to apply the deblur model.

13. The method of claim 12, wherein verifying whether to apply the at least one deblur model comprises determining that a brightness estimate of the image is above a threshold amount.

14. The method of claim 12, wherein verifying whether to apply the at least one deblur model comprises determining that the at least one pixel area is below a threshold area of the image.

15. The method of claim 12, wherein verifying whether to apply the at least one deblur model comprises:
determining a zoom ratio of the image; and
determining that the zoom ratio of the image is below a threshold zoom ratio.

16. The method of claim 1, further comprising:
determining, for each of the at least one pixel area, whether blur in each of the at least one pixel area is primarily caused by optical blur instead of motion blur, wherein determining the depth information for each of the at least one pixel area is based on the determination that the blur is primarily caused by optical blur instead of motion blur.

16. The method of claim 1, further comprising displaying the determined deblurred image.

17. The method of claim 1, wherein the region of interest depicts a person or a face of the person.

18. A computing device comprising:
a control system configured to:
receive, from a sensor, an image;
determine, based on the image, at least one pixel area identified to contain a region of interest within the image;
determine depth information for the at least one pixel area;
based on the depth information for the at least one pixel area, select at least one deblur model from a plurality of deblur models to apply to the at least one pixel area; and
apply the selected at least one deblur model to determine a deblurred image comprising the at least one pixel area, wherein the at least one pixel area is deblurred based on the depth information.

19. The computing device of claim 18, further comprising a plurality of sensors including the sensor, wherein the control system is configured to apply the selected deblur model by causing the computing device to activate at least one additional sensor of the plurality of sensors.

20. A non-transitory computer readable medium storing program instructions executable by one or more processors to cause the one or more processors to perform operations comprising:
receiving, from a sensor, an image;
determining, based on the image, at least one pixel area identified to contain a region of interest within the image;
determining depth information for the at least one pixel area;
based on the depth information for the at least one pixel area, selecting at least one deblur model from a plurality of deblur models to apply to the at least one pixel area; and
applying the selected at least one deblur model to determine a deblurred image comprising the at least one pixel area, wherein the at least one pixel area is deblurred based on the depth information.
